(19) United States
(12) Patent Application Publication
(10) Pub. No.: US 2005/0096877 A1
(43) Pub. Date: May 5, 2005

(54) System and method for determination of load monitoring condition and load monitoring program

(75) Inventors: Kenichi Shimazaki, Kawasaki (JP); Koji Ishibashi, Kawasaki (JP); Jun Katsumata, Kawasaki (JP); Koutaro Tsuro, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/807,497

(22) Filed: Mar. 23, 2004

(30) Foreign Application Priority Data
Oct. 30, 2003 (JP) 2003-369861

(51) Int. Cl. G06F 15/00

(52) U.S. Cl. 702/186

(57) ABSTRACT

The system of the present invention gives a load to a computer system according to load parameter specification from a system administrator, measures a response and a throughput while giving the load to the computer system, then measures a resource situation of each resource while the load is given. Then, it determines load monitoring conditions relating to a monitoring point, a monitoring item and a threshold from results of measuring the response and throughput and the results of measuring the resource situation and performs load monitoring on the determined load monitoring conditions.

### BACKGROUND OF THE INVENTION

1. Field of the Invention

This invention relates to a technology of load monitoring of a computer system (including a computer system comprised of a plurality of computers). In particular, this invention relates to a load monitoring condition determination program, a load monitoring condition determination system, a load monitoring condition determination method and a load monitoring program, which capable of easily determining a load monitoring condition when monitoring a load of the computer system.

Here, information determined as the load monitoring condition is the information including a “monitoring point” indicating which computer is to be monitored, a “monitoring item” indicating which resource item is to be monitored, and a “threshold” indicating what value should be a criterion for monitoring.

2. Description of the Related Art

There is known related art for, as the technology of load monitoring of a computer system, gathering operation information of the system, detecting an abnormal load by using a table having thresholds set in advance and outputting that information to a display apparatus (refer to Patent Document 1: Japanese Patent Laid-Open No. H4-344544 and Patent Document 2: Japanese Patent Laid-Open No. H6-67938 for instance).

There is also known related art for gathering the operation information of the computer system, comparing a load value calculated based on the gathered operation information to the threshold in a monitoring information table, and starting a ganged process by referring to the monitoring information table in the case where the load value exceeds the threshold (refer to Patent Document 3: Japanese Patent Laid-Open No. 2001-134473 for instance).

Further, there is known related art for measuring elements constituting a managed subject, comparing a reference value stored in a reference value storage table to a measured value to acquire a difference between them, and informing a manager of a point in the managed subject highly likely to be abnormal (refer to Patent Document 4: Japanese Patent Laid-Open No. 2002-132543 for instance). This technology updates the reference value in the reference value storage table as required by using the measured value.

As for these related art of load monitoring of the computer system, the work for setting load monitoring conditions such as the monitoring items and thresholds are performed by relying on experience and skills of a system administrator. However, the setting work is also difficult for the system administrator.

As the approach to resolve such difficulty of the setting work, there is art for detecting that the computer system is not normally operating by automatically setting the threshold based on past load information on the computer system (refer to Patent Document 5: Japanese Patent Laid-Open No. 2001-142746 for instance).

It is very difficult work for the system administrator to determine the load monitoring conditions such as “what item should be monitored by using what threshold at what point.” The reason for it is as follows.

1. There are the cases where, even if a certain resource (a hardware resource of the system) is about to be depleted, the computer system is not necessarily abnormal. It makes no sense of monitoring to set the threshold to such a resource. Even if there is a notice of abnormality in such cases, there is no way to deal with it.

2. In the case of the computer system comprised of a plurality of computers, efficient monitoring is performed by setting an appropriate threshold in a portion which is a weak point for the load. However, there are the cases where the weak point of the system is different according to properties of the load (such as size of data, number of system users, processed number per unit time) given from the outside.

Such an event results from difficulty of finding a correlation of external factors like situation of the load given from the outside, to internal factors like situation of the depleted resources inside the computer system for the computer system.

To detect a load abnormality, it is easy if the situation seen from the outside can be monitored. It is difficult, however, to measure the load from the outside as to the present computer system usable by anyone as represented by the Web system. Therefore, a method of determining the situation of the load by using the internal factors which are easily measurable as indexes is generally used. In this case, the actual load situation from the outside cannot be well related to the resource situation inside the computer system, resulting in the difficulty of determining the monitoring method.

As for the approach to resolve the difficulty of determining the monitoring method, there is the art for monitoring it while automatically changing the threshold based on performance such as a characteristic per time and a characteristic per day of the week as with the aforementioned Patent Document 5. The art disclosed therein can certainly eliminate the difficult setting work. However, the monitoring result obtainable by this art is only that “it is different from normal.” To be more specific, the art clarifies that the computer system is operating at higher load than usual. However, it cannot determine exactly whether or not it is abnormal.

### SUMMARY OF THE INVENTION

Accordingly, an object of the present invention is to provide a system and method capable of resolving the aforementioned difficult and uncertain problems of load monitoring and easily performing the work for setting correct load monitoring conditions.

To solve the above problem, the present invention provides a load from the outside of the computer system, and at that time, it measures a response and a throughput outside the computer system and also measures a resource situation inside the computer system so as to determine the load monitoring conditions including a monitoring point, a monitoring item, a threshold or the like from the results thereof.

To be more precise, the present invention is a load monitoring condition determination method for performing the load monitoring of the computer system comprised of one computer or a plurality of computers, and it has the processes of giving the load to the computer system from the outside, measuring the response or throughput outside the computer system while the load is given to the computer system, measuring the resource situation inside the computer system while the load is given to the computer system, and determining a load monitoring conditions adequate to the load monitoring of the computer system from the amount of load given to the computer system from the outside, the results of measuring the response or throughput and the results of measuring the resource situation inside the computer system.

It is possible, by evaluating the load given from the outside of the computer system and the resource situation inside the computer system by relating them, to search for the most effective resource item to be monitored of a large number of indexes of system resource information. To be more specific, it is possible, by examining a reaction of the resource to a change in the amount of load, to determine the resource most necessary to be monitored and the threshold for monitoring it.

Processing according to each of the above steps can be implemented by a computer and a software program, and it is possible either to record the program on a computer-readable record medium or to provide it via a network.

According to the present invention, it is feasible to grasp limit characteristics against the load from the outside of the computer system and be aware of the resource situation inside the computer system of the computer in a close relationship therewith so as to easily determine monitoring indexes. To be more specific, the relationship between the load situation and monitoring indexes becomes clear so that operation of load abnormality monitoring can be more effectively implemented.

### BRIEF DESCRIPTION OF THE DRAWINGS

FIG. 1 is a diagram showing a configuration example of a load monitoring system according to a preferred embodiment of the present invention;

FIG. 2 is a flowchart of a load monitoring process according to this embodiment;

FIG. 3 are diagrams showing examples of a command for measuring a resource situation and results of the command;

FIG. 4 is a flowchart of a load monitoring condition judgment support process;

FIG. 5 is a diagram for explaining determinations of a monitoring point and a monitoring item;

FIG. 6 is a diagram for explaining the determinations of the monitoring point and monitoring item;

FIG. 7 is a diagram for explaining predictions of saturation points of a response and a throughput;

FIG. 8 is a diagram for explaining the predictions of the resource situations of the monitoring point and monitoring item on the saturation of the response; and

FIG. 9 is a diagram for explaining the predictions of the resource situations of the monitoring point and monitoring item on the saturation of the throughput.

### DETAILED DESCRIPTION OF THE PREFERRED EMBODIMENTS

Hereafter, a preferred embodiment of the present invention will be described by using the drawings.

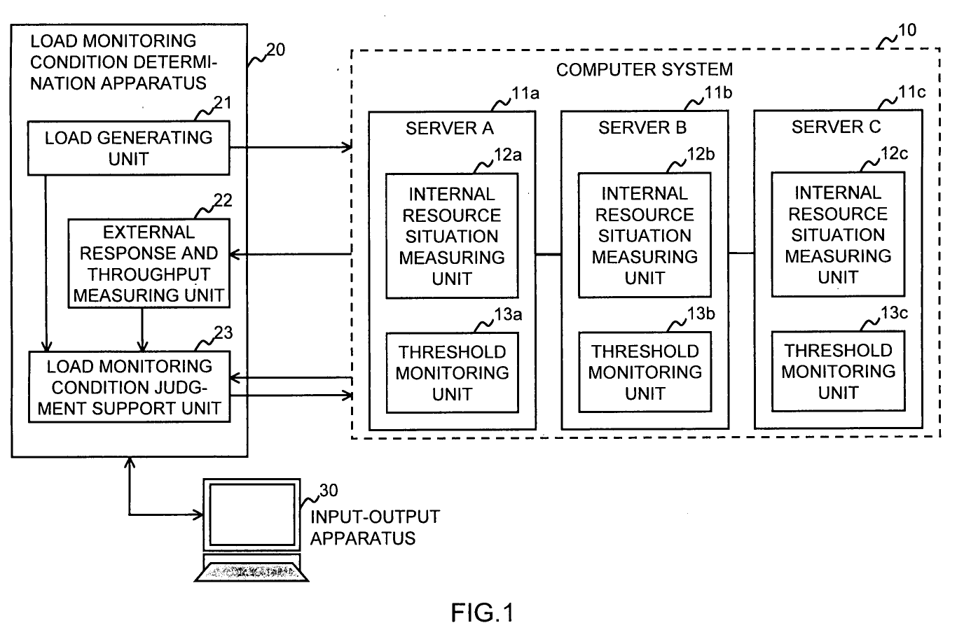

FIG. 1 is a diagram showing a configuration example of a load monitoring system according to a preferred embodiment of the present invention. In the configuration example in FIG. 1, a monitoring subject is a computer system 10 comprised of three servers 11 (computers) of a server A 11a, a server B 11b and a server C 11c. The servers 11a to 11c (hereafter, referred to as the servers 11) comprise internal resource situation measuring units 12a to 12c (hereafter, referred to as the internal resource situation measuring units 12) and threshold monitoring units 13a to 13c (hereafter, referred to as the threshold monitoring units 13). A load monitoring condition determination apparatus 20 comprises a load generating unit 21, an external response and throughput measuring unit 22 and a load monitoring condition judgment support unit 23. The computer system 10 as the monitoring subject is connected to the load monitoring condition determination apparatus 20. The load monitoring condition determination apparatus 20 also has input-output apparatus 30 having such as a display and a keyboard for input and output by an operator (system administrator) connected thereto.

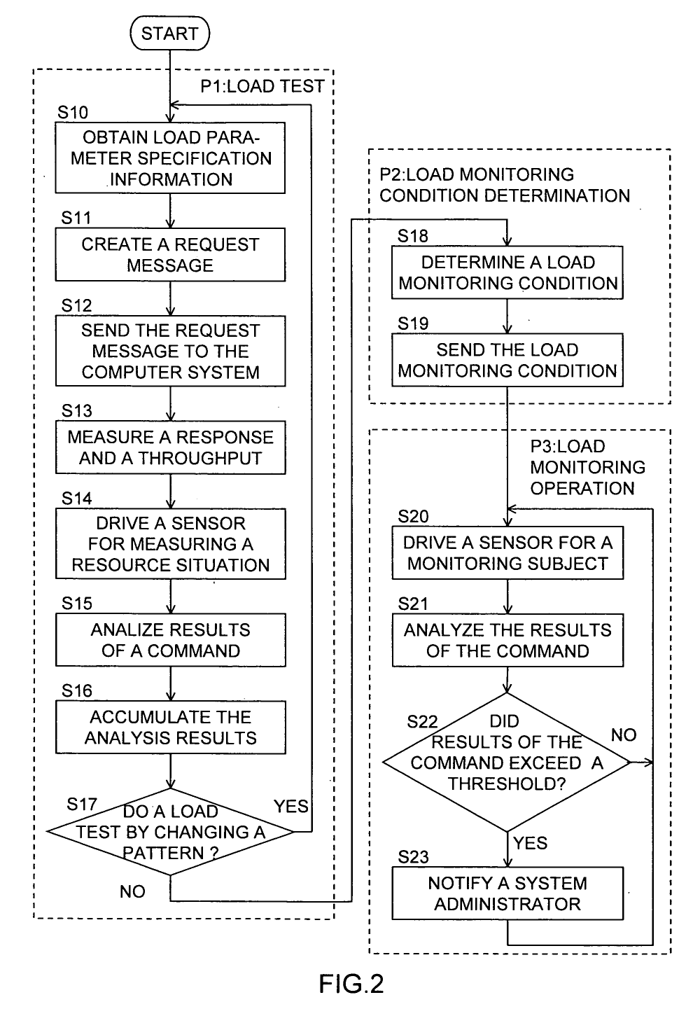

FIG. 2 is a flowchart of a load monitoring process according to this embodiment. This embodiment is comprised, roughly speaking, of a load test phase P1 (steps S10 to S17) for doing a load test for giving the load to the computer system 10 by using the load monitoring condition determination apparatus 20, a load monitoring condition determination phase P2 (steps S18 to S19) for having the load monitoring condition determined by the load monitoring condition determination apparatus 20 based on the results of the load test, and a load monitoring operation phase P3 (steps S20 to S23) for performing the load monitoring in the computer system 10 on the determined load monitoring condition thereafter.

First, in the load test phase P1, the load generating unit 21 receives an instruction from the system administrator and obtains load parameter specification information (step S10), creates a request message according to the load parameter specification information (step S11), and sends the request message to the computer system 10 (step S12). To be more specific, the load generating unit 21 has a load parameter comprised of a combination of a load of size (size of data), a load of the numbers (the numbers of users and connections) and of a load of volumes (the numbers of accesses and transactions per unit time) specified by the system administrator, and creates the request message based on it so as to send the created request message to the computer system 10. The load parameter as the combination of the loads given to the computer system 10 is managed as a load pattern.

The external response and throughput measuring unit 22 measures the response and throughput while the load generating unit 21 is giving the load to the computer system 10 (step S13). The measurement results are sent to the load monitoring condition judgment support unit 23.

While the computer system 10 is given the load by the load monitoring condition determination apparatus 20, the internal resource situation measuring units 12 of each server 11 periodically drives a sensor (command) for measuring the resource situation (step S14), analyses the results of the command (results of measuring the resource situation) (step S15), and accumulates the analysis results (step S16). The accumulated analysis results are sent to the load monitoring condition judgment support unit 23 of the load monitoring condition determination apparatus 20. Here, to analyses and accumulate the results of the command in the steps S15 and S16 means to manage what number a certain item is at a certain time as table data based on the results of measuring the resource situation outputted as the results of the command, for instance.

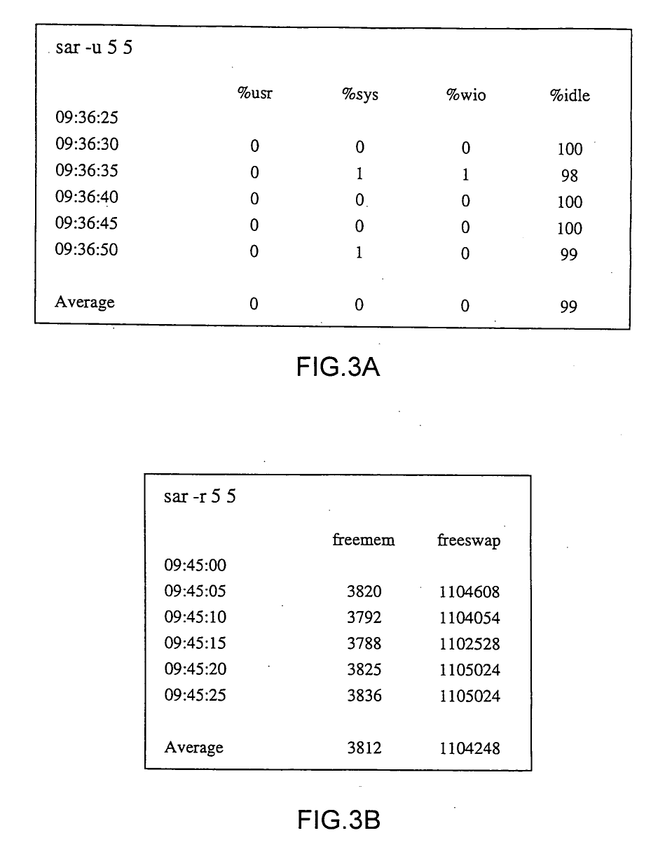

FIG. 3 are diagrams showing examples of the command for measuring the resource situation and the results of the command according to this embodiment. Here, a command “sar” of the UNIX (registered trademark) system is used as the command for measuring the resource situation.

FIG. 3A is an example of the command for measuring the resource situation of a CPU and the results of the command. Here, a “-u” option following the command “sar” specifies an information output of the CPU. “55” following the “-u” option specifies the measurement of five times at intervals of 5 seconds. The example of the command results in FIG. 3A shows five measurement results as to the items “% usr”, “% sys”, “% wio” and “% idle” every 5 seconds. “Average” at the end indicates an average of the measurement of five times as to each item. Here, each of the items “% usr”, “% sys”, “% wio” and “% idle” will be described later.

FIG. 3B is an example of the command for measuring the resource situation of the memory and the results of the command. Here, an “-r” option following the command “sar” specifies the information output of the memory. “55” following the “-r” option specifies the measurement of five times at intervals of 5 seconds. The example of the command results in FIG. 3B shows five measurement results as to the items “freemem” and “freeswap” every 5 seconds. The “Average” at the end indicates the average of the measurement of five times as to each item. Here, each of the items “freemem” and “freeswap” will be described later.

The processes of the steps S10 to S16 are repeated by changing the pattern of the load parameter (steps S17).

Next, the load monitoring condition determination apparatus 20 moves on to the load monitoring condition determination phase P2 for determining the load monitoring condition based on the results of the load test (steps S10 to S17). In the phase P2, the load monitoring condition judgment support unit 23 checks the pattern of the load parameter used for the load test, the measurement results of the response and throughput, and the analysis results of the resource situation inside the computer system 10 against one another so as to determine the load monitoring condition (step S18). At this time, it presents the load test results to the system administrator if necessary and prompts the instruction. It is thereby possible to judge which server 11 (monitoring point) and which resource item (monitoring item) respond best to the given load and are suitable for monitoring indexes so as to set an appropriate threshold for monitoring the monitoring item.

If the load monitoring condition is determined in the step S18, the load monitoring condition judgment support unit 23 sends the determined load monitoring condition to the threshold monitoring unit 13 of the applicable server 11 (monitoring point) (step S19).

Thereafter, it moves on to the load monitoring operation phase P3, where the load monitoring in the computer system 10 on the determined load monitoring condition is performed (steps S20 to S23). In the load monitoring operation phase P3, during the operation of the computer system 10, the threshold monitoring unit 13 periodically drives the sensor (command) for the monitoring subject (step S20), analyses the results of the command (results of measuring the resource situation) (step S21), and if the command results exceed the threshold (step S22), it notifies the system administrator thereof (step S23).

Here, it is thinkable, as a method of handling the cases where the command results exceed the threshold, to exert control such as limiting reception of the requests from the outside of the computer system 10. It is also thinkable, as the method of handling the cases, to automatically balance resource allocation among applications and among a plurality of computers by using the thresholds.

Here, it was described that the resource situation could be measured by the command. However, the sensor for the monitoring subject may be either hardware or a software program installed in an operating system for instance. As for the method of measuring the resource situation, it is possible to use the method conventionally employed in general.

There are the following three approaches, roughly speaking, as to a work flow for judging the monitoring method from the results of measuring the resource situation by the load test and lastly determining the load monitoring condition.

(1) To check marginal performance of the system.

If the marginal performance of the computer system 10 is checked by the load tests, it is possible to adopt the state of a system resource which responded well, that is worked well with the applied load, as-is as the monitoring mode then so as to determine an appropriate load monitoring condition most securely. Although it is the most secure approach, it requires time for the load tests.

(2) To predict the marginal performance of the system from a trend of external response and throughput.

System limits such as saturation points of the response and throughput are derived from the results of three to five load tests, and the state of the system resource at the time is calculated back. While it does not require as many load tests as the above (1), the system limits (accuracy of thresholds) are within a predicted range. It is used in combination with the approach of the following (3).

(3) To judge the marginal performance from physical limitation of an internal resource responding linearly to the load from the outside.

The internal resource linearly responding well, that is working well with the applied load, is checked from the results of the three to five load tests, and the threshold is determined with a physical limitation point of the resource as a viewpoint. It is used in combination with the approach of the above (2).

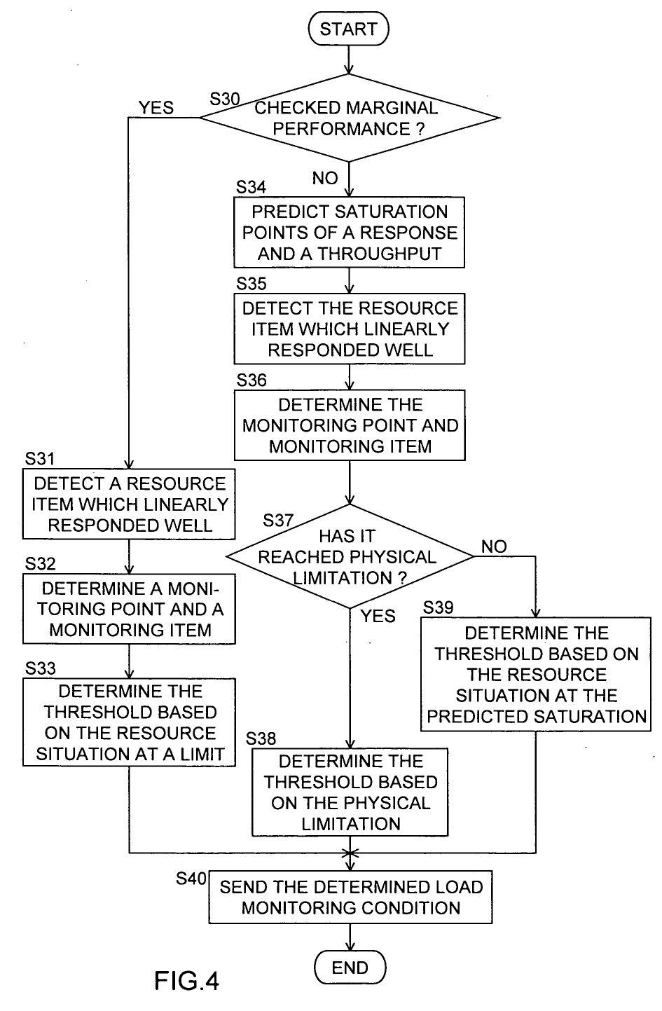

FIG. 4 is a flowchart of a load monitoring condition judgment support process according to this embodiment. A detailed description will be given by using FIG. 4 as to determination of the load monitoring condition in the load monitoring condition judgment support unit 23.

First, it is judged whether or not the marginal performance of the computer system 10 against the load from the outside was checked from the load test results (step S30). If the marginal performance is checked, the resource item which linearly responded well against the load from the outside (worked well with the applied load) is detected (step S31). The server 11 (computer) to which the detected resource belongs is determined as the monitoring point, and the detected resource item is determined as the monitoring item (step S32). An optimum threshold is determined based on the measurement results of the resource situation measured at the monitoring point and monitoring item at the limit (step S33).

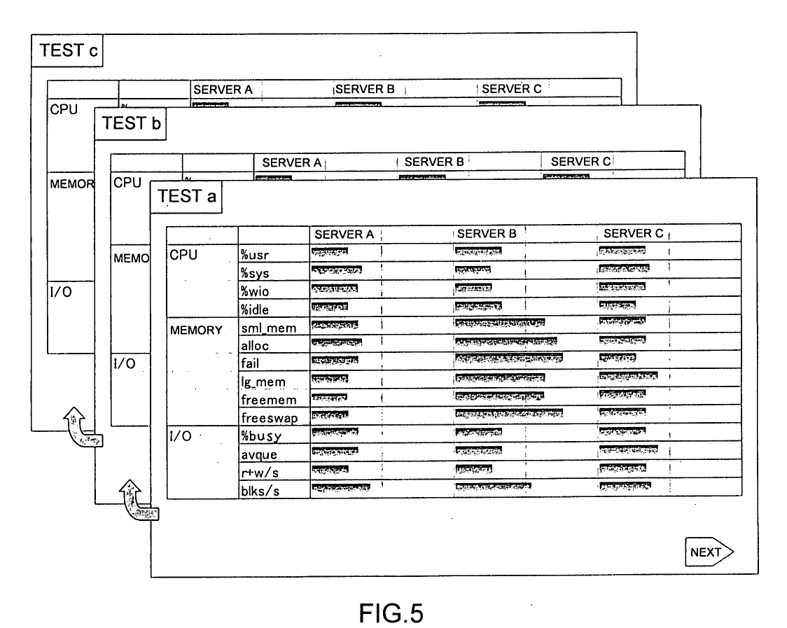

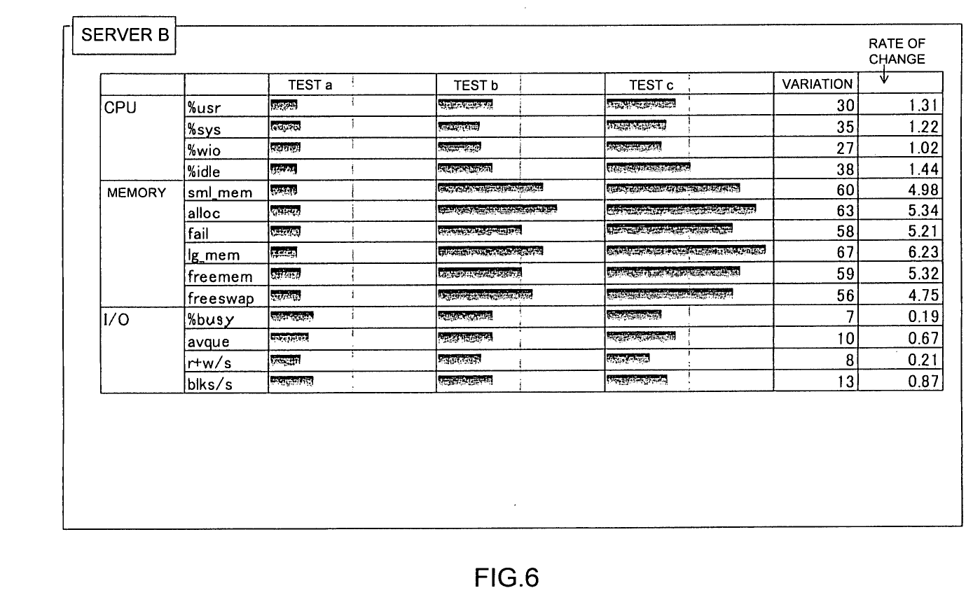

FIGS. 5 and 6 are diagrams for explaining the determinations of the monitoring point and monitoring item according to this embodiment. The information shown in FIG. 5 is the information in which the measurement results of each of the resource situation of each server 11 are organized for each of the load tests (tests a to c) of which load parameters are changed or the information obtainable from the results of measuring the resource situation by the internal resource situation measuring unit 12 of each server 11. The information shown in FIG. 6 is the information in which the results of the three load tests (tests a to c) are summarized as to the server B lb. Here, it is assumed that the amount of load applied to the computer system 10 is as follows.

The amount of load (test a)<the amount of load (test b)<the amount of load (test c)

In FIG. 6, variation means the information on a difference between the results of the test a and the results of the test c, and a rate of change means percentage of the change.
Variation=(results of the test c)−(results of the test a)
Rate of change={(results of the test c)−(results of the test a)}/(results of the test a)
For instance, the resource item of the highest rate of change is determined as the monitoring item.

Of many resource items, each of the examples in FIGS. 5 and 6 takes several items as the examples as to the resources of the CPU, memory and input-output apparatus (I/O). The items taken as the examples in FIGS. 5 and 6 will be briefly described hereafter.

Examples of CPU monitoring items

“% usr”: CPU time for which it operated in a user mode
“% sys”: CPU time for which it operated in a system mode other than remote
“% wio”: Time for which it was not in an idle state
“% idle”: Wait time for input-output completion
   Examples of memory monitoring items
“sml_mem”: Amount of available memory held in a small memory request pool
“alloc”: Amount of memory allocated from the small memory request pool
“fail”: Number of failures in allocation of small memory requests
“lg_mem”: Amount of available memory held in a large memory request pool
“freemem”: Number of memory pages available to a user process
“freeswap”: Number of free swap pages
   Examples of I/O monitoring items
“% busy”: Time spent on transfer request service by the apparatus
“avque”: Average number of requests attached to a queue
“r+w/s”: Number of reads and writes transferred to the apparatus
“blks/s”: Number of blocks transferred to the apparatus

Although only the items listed in FIGS. 5 and 6 were described above, there are a number of items other than those described here.

Of these resource items, the one which responded well to the load from the outside is detected. For instance, it can be seen in FIG. 5 that the server B 11b is responding better on the whole than the server A11a and server C 11c. And it can be seen in FIG. 6 that the item “lg_mem” of the memory is responding better than the other items. It is possible to determine the monitoring point and monitoring item from such information.

It is also possible to present the tables shown in FIGS. 5 and 6 to the system administrator. It is also possible to have the monitoring point and monitoring item automatically determined by the load monitoring condition judgment support unit 23 or have them determined by the system administrator based on the information in FIGS. 5 and 6.

In the step S30, if it is not possible to load the computer system 10 to the limit and check the marginal performance, the saturation points (limits) of the response and throughput are predicted from the results of the load tests on a plurality of load parameter patterns (step S34). And the resource item which linearly responded well to the load from the outside is detected (step S35). The server 11 to which the detected resource belongs is determined as the monitoring point, and the detected resource item is determined as the monitoring item (step S36).

Here, a description will be given as to the prediction of the saturation points (limits) of the response and throughput. The saturation points of the response and throughput indicate the points at which the values of the response and throughput of the computer system 10 to the given load become the values almost close to the limits. It is possible to predict the saturation points of the response and throughput, for example, based on the results of several load tests of which load parameter patterns are changed.

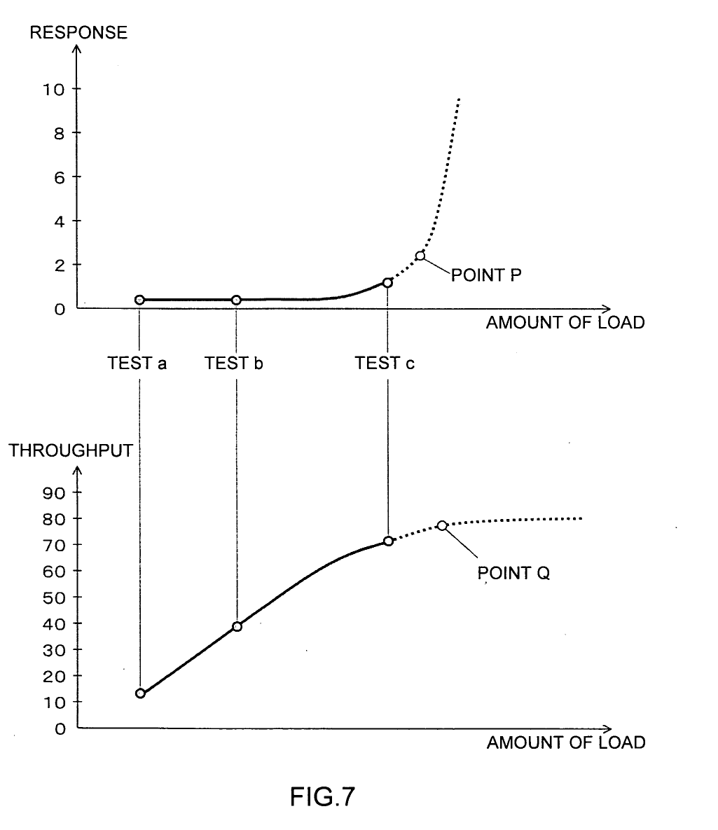

FIG. 7 is a diagram for explaining the predictions of the saturation points of the response and throughput according to this embodiment. The upper portion of FIG. 7 shows an example of the prediction of the saturation point of the response from the results of the load tests with three patterns of load parameters, and the lower portion of FIG. 7 shows an example of the prediction of the saturation point of the throughput from the results of the load tests with three patterns of load parameters.

In the upper portion of FIG. 7, a horizontal axis indicates the amount of load given to the computer system 10, and a vertical axis indicates the value of the response. The response is a maximum response time of one transaction from sending the request message to responding to it. In the lower portion of FIG. 7, the horizontal axis indicates the amount of load given to the computer system 10, and the vertical axis indicates the value of the throughput. The throughput is the number of request messages (transactions) processed in a unit time. In FIG. 7, a full line portion of a curve indicates the curve obtained from the results of the load tests, and a dotted line portion indicates a predicted curve.

As for a method of predicting the saturation point of the response, as shown in the upper portion of FIG. 7, for instance, there is the method of predicting the curve (hereafter, referred to as a response curve) indicating the response to the amount of load to the computer system 10 from the results of the responses measured by the several load tests (three load tests in the upper portion of FIG. 7 with different parameters so as to predict the saturation point (point P) from the response curve obtained by the prediction. The predicted saturation point (point P) of the response is the point at which the response value drastically rises (rising point of the response curve), for instance.

As for a method of predicting the saturation point of the throughput, as shown in the lower portion of FIG. 7, for instance, there is the method of predicting the curve (hereafter, referred to as a throughput curve) indicating the throughput to the amount of load to the computer system 10 from the results of the throughputs measured by the several load tests (three load tests in the lower portion of FIG. 7) with different parameters so as to predict the saturation point (point Q) from the throughput curve obtained by the prediction. The predicted saturation point (point Q) of the throughput is the point at which the throughput value almost becomes constant (point at which the throughput curve almost becomes level), for instance.

Although the predictions of the response curve and throughput curve and the predictions of the saturation points of the response and throughput are automatically performed by the load monitoring condition judgment support unit 23, it is also possible to have the information necessary for the judgment of the saturation points and provided to the system administrator as support for the predictions by the load monitoring condition judgment support unit 23 so as to have the predictions made by the system administrator.

As for a method of having the curves automatically predicted by the load monitoring condition judgment support unit 23, there is the method, for instance, of experientially setting a formula for the curves (usually a multidimensional formula) in advance and assigning the load test results to that formula to predict the curve. There is another method whereby a plurality of curve patterns are prepared in advance and the curve which is the closest to the load test results is selected thereof.

As for a method of having the saturation points automatically predicted by the load monitoring condition judgment support unit 23, there is the method, for instance, whereby a ratio of an increment of a y axis (response or throughput) against a constant increment of an x axis (amount of load) in FIG. 7 is calculated and it is deemed to have reached the limit if the ratio exceeds a predetermined value (in the case of the response) or is below the predetermined value (in the case of the throughput) so as to determine that point as the saturation point.

As for a method of having the necessary information provided to the system administrator as support for the predictions by the load monitoring condition judgment support unit 23, as shown in FIG. 7 for instance, there is the method of plotting the load test results as a graph and indicating it on the display or the like. The system administrator can predict the curves and the saturation points, for example, by drawing a predicted curve in the graph on the display with a mouse and specifying the portions deemed as the saturation points on the curve. There is also the method whereby, instead of having the predicted curves drawn by the system administrator on predicting the curves, several curve predictions are prepared in advance by the load monitoring condition judgment support unit 23 and the predicted curves are selected thereof by the system administrator.

It is also possible to have either the curves or the saturation points automatically predicted by the load monitoring condition judgment support unit 23 and have the other predicted by the system administrator. It is further possible to have the system administrator select whether the predictions should be automatically made by the load monitoring condition judgment support unit 23 or by the system administrator. It is also feasible to have the load monitoring condition judgment support unit 23 present the load test results to the system administrator as the graphs shown in FIG. 7 for instance regardless of whether or not the predictions are automatically made.

If the monitoring point and monitoring item are determined in the step S36, it is determined whether or not the resource determined as the monitoring item has reached the physical limitation by the load tests (step S37). If it has reached the physical limitation, the threshold is determined based on a physical limitation value of the resource (step S38).

Here, the physical limitation refers to the limits of the resources such as a memory capacity or a storage capacity of a disk. If the results indicating the physical limitation of the resource determined as the monitoring item are obtained during several load tests, the threshold can be determined based on the physical limitation of the resource.

In the case where it has not reached the physical limitation in the step S37, predictions are made as to the resource situations of the monitoring point and monitoring item on the saturation of the response and throughput predicted in the step S34, and the threshold is determined based thereon (step S39).

Here, a description will be given as to the predictions of the resource situations of the monitoring point and monitoring item on the saturation of the response and throughput.

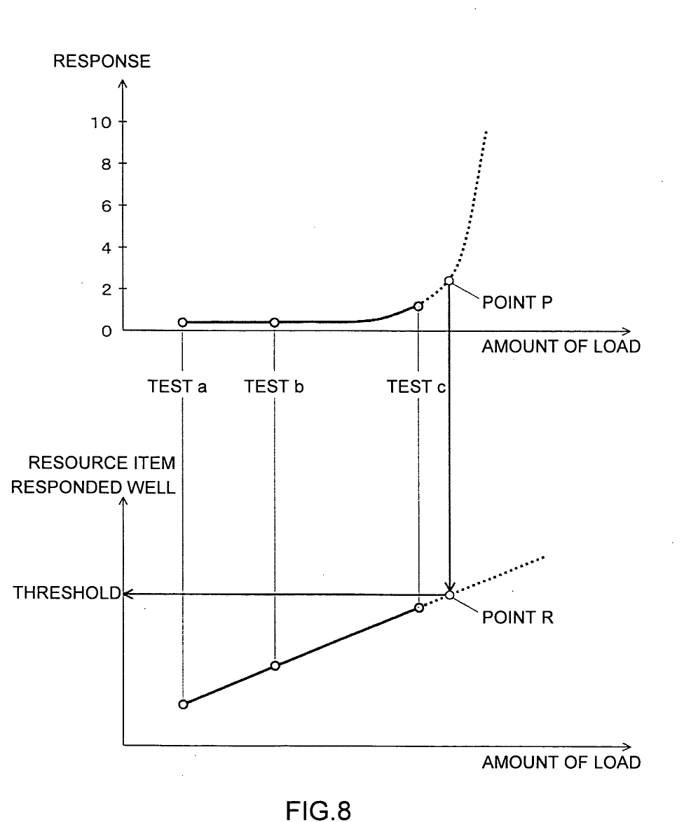

FIG. 8 is a diagram for explaining the predictions of the resource situations of the monitoring point and monitoring item on the saturation of the response according to this embodiment. The upper portion of FIG. 8 shows the prediction of the saturation point (point P) of the response from the results of the load tests with the three patterns of load parameters, and the lower portion of FIG. 8 shows the predictions of the resource situations of the monitoring point and monitoring item on the saturation of the response from the results of the load tests with the three patterns of load parameters.

In the upper portion of FIG. 8, the horizontal axis indicates the amount of load given to the computer system 10, and the vertical axis indicates the value of the response. In the lower portion of FIG. 8, the horizontal axis indicates the amount of load given to the computer system 10, and the vertical axis indicates the value of the resource situation of the resource determined as the monitoring item. In FIG. 8, the full line portion indicates the line obtained from the results of the load tests, and a dotted line portion indicates the predicted line. And in the lower portion of FIG. 8, the point R is the point indicating the predicted value of the resource situation on the saturation of the predicted response.

It is also possible, as with the aforementioned predictions of the curves of the response and throughput, to have the prediction of the line indicating the resource situation of the resource determined as the monitoring item for the amount of load to the computer system 10 automatically made by the load monitoring condition judgment support unit 23. Or else, it is possible to have the necessary information provided to the system administrator as the support for the predictions by the load monitoring condition judgment support unit 23 so as to have the prediction of the line made by the system administrator. The method thereof may be the same as the aforementioned method of predicting the curves of the response and throughput.

If the line indicating the resource situation for the amount of load to the computer system 10 is predicted, the load monitoring condition judgment support unit 23 acquires a point (point R) indicating the same amount of load as that indicated by the saturation point (point P) of the response predicted in the step S33 on the line indicating the predicted resource situation. For instance, it is possible to determine the predicted value of the resource situation indicated by the R point as the threshold. However, in the case where the predicted value of the resource situation indicated by the R point has already exceeded the physical limitation value of the resource determined as the monitoring item, the threshold is determined based on the physical limitation value of the resource determined as the monitoring item as in the step S36.

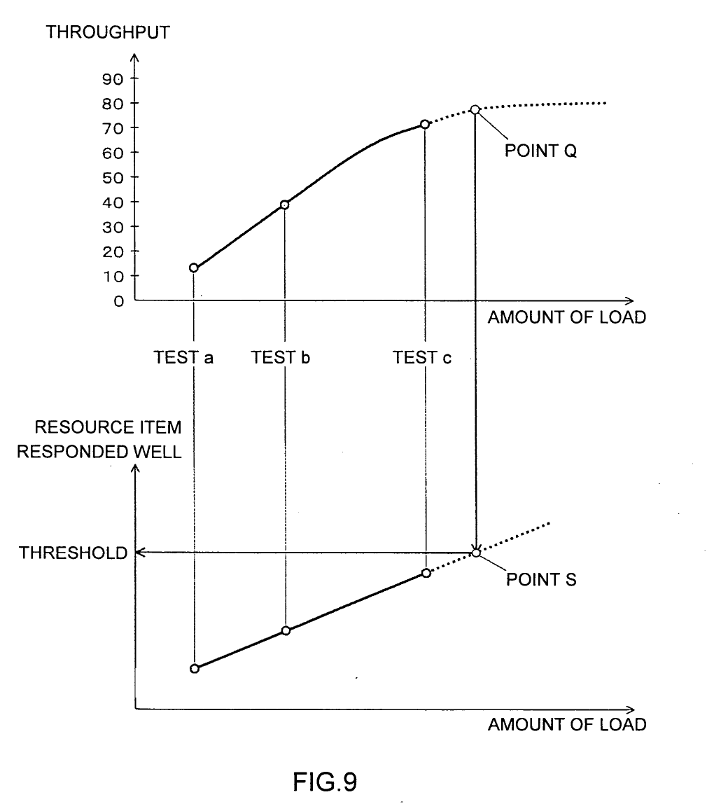

FIG. 9 is a diagram for explaining the predictions of the resource situations of the monitoring point and monitoring item on the saturation of the throughput according to this embodiment. The upper portion of FIG. 9 shows the prediction of the saturation point (point Q) of the throughput from the results of the load tests with the three patterns of load parameters. The lower portion of FIG. 9 shows the predictions of the resource situations of the monitoring point and monitoring item on the saturation of the throughput from the results of the load tests with the three patterns of load parameters.

In the upper portion of FIG. 9, the horizontal axis indicates the amount of load given to the computer system 10, and the vertical axis indicates the value of the throughput. In the lower portion of FIG. 9, the horizontal axis indicates the amount of load given to the computer system 10, and the vertical axis indicates the value of the resource situation of the resource determined as the monitoring item. In FIG. 9, the full line portion indicates the line obtained from the results of the load tests, and the dotted line portion indicates the predicted line. And in the lower portion of FIG. 9, the point S is the point indicating the predicted value of the resource situation on the saturation of the predicted throughput.

It is also possible, as with the aforementioned predictions of the curves of the response and throughput, to have the prediction of the line indicating the resource situation of the resource determined as the monitoring item for the amount of load to the computer system 10 automatically made by the load monitoring condition judgment support unit 23. Or else, it is possible to have the necessary information provided to the system administrator as the support for the predictions by the load monitoring condition judgment support unit 23 so as to have the prediction of the line made by the system administrator. The method thereof may be the same as the aforementioned method of predicting the curves of the response and throughput.

If the line indicating the resource situation for the amount of load to the computer system 10 is predicted, the load monitoring condition judgment support unit 23 acquires a point (point S) indicating the same amount of load as that indicated by the saturation point (point Q) of the throughput predicted in the step S33 on the line indicating the predicted resource situation. For instance, it is possible to determine the predicted value of the resource situation indicated by the point S as the threshold. In the case where the predicted value of the resource situation indicated by the point S has already exceeded the physical limitation value of the resource determined as the monitoring item, the threshold is determined based on the physical limitation value of the resource determined as the monitoring item as in the step S36.

Here, as shown in FIGS. 8 and 9, the threshold on the saturation of the response and that on the saturation of the throughput are normally different values. One of the values is determined as the threshold depending on the character and nature of the computer system 10.

The load monitoring conditions (monitoring point, monitoring item and threshold) determined by the load monitoring condition judgment support process in the steps S30 to S37 are sent to the computer system 10. Thereafter, the load monitoring is performed on the determined load monitoring conditions on the computer system 10.

The predictions of the response curve and throughput curve (FIG. 7) and the predictions of the line of the resource situation (the lower portions of FIGS. 8 and 9 are separately made in the flowchart of the example in FIG. 4. It is also possible, however, to make these predictions at the same time and display the graphs of the prediction results of the two lines simultaneously as in FIGS. 8 and 9 so as to have the saturation points and thresholds determined at once by the system administrator.

The embodiment of the present invention was described above. However, the present invention is not limited thereto. For instance, the configuration example of the load monitoring system in FIG. 1 has the load generating unit 21, external response and throughput measuring unit 22 and load monitoring condition judgment support unit 23 implemented as one piece of hardware, but they may be implemented as separate pieces of hardware respectively.

According to this embodiment, the threshold is determined only as to the (one) most responsive resource item. However, it is also possible, for instance, to determine the thresholds of a plurality of resource items, such as determining the thresholds as to 5 top responsive resource items.

1. A load monitoring condition determination method for determining a load monitoring condition for performing load monitoring of a computer system comprised of one computer or a plurality of computers, wherein the method comprises the steps of:
giving a load to the computer system from the outside;
measuring a response or a throughput outside the computer system while the load is given to the computer system;
measuring a resource situation inside the computer system while the load is given to the computer system; and
determining a load monitoring condition used for the load monitoring of the computer system from the amount of load given to the computer system from the outside, the results of measuring the response or throughput and the results of measuring the resource situation inside the computer system.

2. The load monitoring condition determination method according to claim 1, wherein the load monitoring condition includes at least information on a monitoring item indicating which item of which resource should be monitored and a threshold to be used for monitoring of the monitoring item; and
the step of determining the load monitoring condition includes the steps of:
relating the load given from the outside to the results of measuring the resource situation inside the computer system,
thereby detecting a resource item having responded well to the load,
rendering the resource item as the monitoring item, and
determining the threshold as a criterion for monitoring the resource item by any of means of marginal performance or predicted value of the measured response or throughput or physical limitation of the resource based on the results of measuring the resource situation.

3. The load monitoring condition determination method according to claim 2, wherein the step of determining the threshold includes the steps of:
in the case where the results of measuring the response or throughput show the marginal performance, determining the threshold based on the results of measuring the resource situation of the monitoring item at that time;
in the case where the resource determined as the monitoring item shows physical limitation, determining the threshold based on the physical limitation; and
if the results of measuring the response or throughput do not show the marginal performance and the resource determined as the monitoring item does not show the physical limitation, predicting the marginal performance of the response or throughput from the results of measuring the response or throughput, predicting the resource situation of the monitoring item at the predicted marginal performance of the response or throughput from the results of measuring the resource situation inside the computer system, and determining the threshold based on the predicted resource situation.

4. The load monitoring condition determination method according to claim 1, wherein the step of determining the load monitoring condition includes the steps of:
presenting, to a system administrator, information on the amount of load given to the computer system, the results of measuring the response or throughput and the results of measuring the resource situation inside the computer system; and
having a part or all of the load monitoring conditions optimum for load monitoring of the computer system selected by the system administrator and setting the selected information as the load monitoring conditions.

5. A load monitoring condition determination system for determining a load monitoring condition for performing load monitoring of a computer system comprised of one computer or a plurality of computers, wherein the system comprises:
load generating means for giving a load to the computer system;
external response and throughput measuring means for measuring a response or a throughput of the computer system while giving the load to the computer system; and
load monitoring condition judgment support means for determining a load monitoring condition used for load monitoring of the computer system from the amount of load given to the computer system, the results of measuring the response or throughput and the results of measuring the resource situation inside the computer system while giving the load to the computer system.

6. The load monitoring condition determination system according to claim 5, wherein the load monitoring condition includes at least information on a monitoring item indicating which item of which resource should be monitored and a threshold to be used for monitoring of the monitoring item; and
the load monitoring condition judgment support means comprises the means for:
detecting a resource item having responded well to the load given from the outside of the computer system from the results of measuring the resource situation inside the computer system;
determining the detected resource item having responded well as the monitoring item;
in the case where the results of measuring the response or throughput show the marginal performance, determining the threshold based on the results of measuring the resource situation of the monitoring item at that time;
in the case where the resource determined as the monitoring item shows physical limitation, determining the threshold based on the physical limitation; and
if the results of measuring the response or throughput do not show the marginal performance and the resource determined as the monitoring item does not show the physical limitation, predicting the marginal performance of the response or throughput from the results of measuring the response or throughput, predicting the resource situation of the monitoring item at the predicted marginal performance of the response or throughput from the results of measuring the resource situation inside the computer system, and determining the threshold based on the predicted resource situation.

7. A load monitoring condition determination program for causing a computer to execute a method for determining a load monitoring condition for performing load monitoring of a computer system comprised of one computer or a plurality of computers, wherein the program causes the computer to execute the steps of:
giving a load to the computer system from the outside;
measuring a response or a throughput outside the computer system while the load is given to the computer system;
receiving from the computer system the results of measuring the resource situation inside the computer system while the load is given to the computer system; and
determining the load monitoring condition used for load monitoring of the computer system from the amount of load given to the computer system from the outside, the results of measuring the response or throughput and the results of measuring the resource situation inside the computer system.

8. The load monitoring condition determination program according to claim 7, wherein the load monitoring condition includes at least information on a monitoring item indicating which item of which resource should be monitored and a threshold to be used for monitoring of the monitoring item; and
the step of determining the load monitoring condition causes the computer to execute the step of:
relating the load given from the outside to the results of measuring the resource situation inside the computer system,
thereby detecting a resource item having responded well to the load and rendering the resource item as the monitoring item,
determining the threshold as a criterion for monitoring the resource item by any of means of marginal performance or a predicted value of the measured response or throughput or physical limitation of the resource based on the results of measuring the resource situation.

9. The load monitoring condition determination program according to claim 8, wherein the step of determining the threshold causes the computer to execute the steps of:
in the case where the results of measuring the response or throughput show the marginal performance, determining the threshold based on the results of measuring the resource situation of the monitoring item at that time;
in the case where the resource determined as the monitoring item shows physical limitation, determining the threshold based on the physical limitation; and
if the results of measuring the response or throughput do not show the marginal performance and the resource determined as the monitoring item does not show the physical limitation, predicting the marginal performance of the response or throughput from the results of measuring the response or throughput, predicting the resource situation of the monitoring item at the predicted marginal performance of the response or throughput from the results of measuring the resource situation inside the computer system, and determining the threshold based on the predicted resource situation.

10. The load monitoring condition determination program according to claim 7, wherein the step of determining the load monitoring condition includes, and causes the computer to execute the steps of:
presenting, to a system administrator, information on the amount of load given to the computer system, the results of measuring the response or throughput and the results of measuring the resource situation inside the computer system; and
having a part or all of the load monitoring conditions optimum for the load monitoring of the computer system selected by the system administrator and setting the selected information as the load monitoring conditions.

11. A load monitoring program for causing a computer to execute a method for determining a load monitoring condition for performing load monitoring of a computer system comprised of one computer or a plurality of computers and performing the load monitoring on that load monitoring condition, wherein the program causes the computer or computers constituting the computer system to execute the steps of:
giving a load to the computer system from the outside;
measuring a response or a throughput outside the computer system while the load is given to the computer system;
receiving from the computer system the results of measuring the resource situation inside the computer system while the load is given to the computer system; and
determining a load monitoring condition used for load monitoring of the computer system from the amount of load given to the computer system from the outside, the results of measuring the response or throughput and the results of measuring the resource situation inside the computer system; and
setting the load monitoring condition determined by causing the computer for determining the load monitoring condition to execute the steps and using the set load monitoring condition so as to perform the load monitoring of the computer system.

12. A load monitoring system for determining a load monitoring condition for performing load monitoring of a computer system comprised of one computer or a plurality of computers and performing the load monitoring on that load monitoring condition, wherein the system comprises:
load generating means for giving a load to the computer system;
external response and throughput measuring means for measuring a response or a throughput of the computer system while giving the load to the computer system;
load monitoring condition judgment support means for determining the load monitoring condition used for the load monitoring of the computer system from the amount of load given to the computer system, the results of measuring the response or throughput and the results of measuring the resource situation inside the computer system while giving the load to the computer system; and
threshold monitoring means for performing the load monitoring of the computer system by using the determined load monitoring condition.
